(19) United States
(12) Patent Application Publication
(10) Pub. No.: US 2022/0380173 A1
(43) Pub. Date: Dec. 1, 2022

(54) ELEVATOR SYSTEM AND METHOD FOR RESTORING OPERATION OF AN ELEVATOR CAR

(71) Applicant: Otis Elevator Company, Farmington, CT (US)

(72) Inventors: Dirk H. Tegtmeier, Berlin (DE); Peter Herkel, Berlin (DE)

(21) Appl. No.: 17/529,563

(22) Filed: Nov. 18, 2021

(30) Foreign Application Priority Data
May 28, 2021 (EP) 21176745.4

(51) Int. Cl. B66B 5/00; B66B 1/34

(52) U.S. Cl. CPC B66B 5/0025; B66B 5/0031; B66B 1/3415

(57) ABSTRACT

An elevator system includes an elevator car, an elevator controller, a safety controller and a plurality of safety contacts connected to the safety controller, wherein the plurality of safety contacts monitor the elevator system. The safety controller is configured to receive individual status information from each of the plurality of safety contacts and to prevent movement of the elevator car when the individual status information received from one of the plurality of safety contacts indicates an unsafe condition of the elevator system. The safety controller is configured to connect to a remote computing device, to receive first authentication information from the remote computing device, and to authenticate the remote computing device if the first authentication information meets an authentication condition. If the remote computing device is authenticated, to permit the remote computing device to override the safety controller to enable movement of the elevator car.

### FOREIGN PRIORITY

This application claims priority to European Patent Application No. 21176745.4, filed May 28, 2021, and all the benefits accruing therefrom under 35 U.S.C. § 119, the contents of which in its entirety are herein incorporated by reference.

### TECHNICAL FIELD

This disclosure relates to an elevator system and a method of restoring operation of an elevator car in an elevator system.

### BACKGROUND

It is known to provide a safety chain within an elevator system, where each switch, or safety contact, in the safety chain corresponds to a separate component of the elevator system, e.g. door sensors detecting whether a door lock has engaged. The safety chain is configured such that the activation of a single safety contact, e.g. the opening of a single switch in the safety chain, due to a failure of any one of the sensed components, prevents operation of the elevator system.

It is furthermore known that once a safety contact has been activated a maintenance person will be called out to the elevator system. They will manually inspect the elevator system, identify, and rectify the fault, in order to restore operation of the elevator system.

Where a safety contact is activated whilst an elevator car of the elevator system is in motion, this will result in an emergency stop of the elevator car. Such an emergency stop results in any passengers within the stopped car(s) being trapped inside the elevator car(s). It is desirable that any trapped passengers be released as quickly as possible, since it is an unpleasant experience for passengers being trapped within an elevator car. It is known for such an emergency rescue operation (ERO) to be carried out manually by a maintenance person, who must be present locally on site. The maintenance person operates a control panel of the elevator system to move the elevator car along the hoistway to a landing, and after stopping the car at the landing, opens the elevator car door.

### SUMMARY

According to a first aspect of this disclosure there is provided an elevator system comprising: an elevator car; an elevator controller, configured to control operation of the elevator car; and a safety controller and a plurality of safety contacts connected to the safety controller, wherein the plurality of safety contacts monitor the elevator system, wherein the safety controller is configured to receive individual status information from each of the plurality of safety contacts and to prevent movement of the elevator car when the individual status information received from one of the plurality of safety contacts indicates an unsafe condition of the elevator system; wherein the safety controller is configured to connect to a remote computing device, to receive first authentication information from the remote computing device, and to authenticate the remote computing device if the first authentication information meets an authentication condition; and if the remote computing device is authenticated, to permit the remote computing device to override the safety controller to enable movement of the elevator car.

According to a second aspect of the present disclosure, there is provided a method of restoring operation of an elevator car in an elevator system, when a safety controller is preventing movement of the elevator car since the individual status information from one of a plurality of safety contacts, received by the safety controller, indicates an unsafe condition of the elevator system, wherein an elevator controller controls operation of the elevator car; the method comprising: the safety controller establishing a connection with a remote computing device; the remote computing device sending first authentication information to the safety controller; the safety controller checking whether the first authentication information meets an authentication condition; and if the first authentication information meets the authentication condition, authenticating the remote computing device; and if the remote computing device is authenticated, permitting the remote computing device to override the safety controller to enable movement of the elevator car.

By authenticating a remote computing device directly with the safety controller, it is possible to realize a secure connection by which authorized personnel only are able to remotely access the safety system and override the safety controller. It will be understood that overriding of the safety controller refers to overriding the automatic action of the safety controller which normally prevents movement of the elevator car (e.g. disconnection of the drive power supply) such that once again movement of the elevator car is permitted. In order to override the safety controller, the remote computing device acts in any suitable way to reverse the indication of an unsafe condition from one of the safety contacts. This may, for example, involve an override command from the remote computing device to the safety controller. In at least some examples, the remote computing device can override the safety controller by bridging the safety contacts that indicated an unsafe condition, e.g. using software of the safety controller. Such an override is required in order to re-enable movement of the elevator car e.g. following an emergency stop due to the opening of a safety contact. It is particularly important that movement of the elevator car is re-enabled where passengers are trapped within the elevator car following an emergency stop. By carrying out the override using a remote computing device, a maintenance person can therefore recover trapped passengers without having to make a physical visit to the elevator system. This reduces the time in which trapped passengers can be recovered, and also improves efficiency and convenience of carrying out a recovery operation for the elevator system.

It will be understood that the safety controller is separate from the elevator controller. Thus authentication of the remote computing device by the safety controller does not grant authenticated access to the elevator controller, and likewise a separate authentication to the elevator controller does not grant authenticated access to the safety controller or permission to override the safety controller. Thus authenticating directly with the safety controller, which is separate from the elevator controller, provides an increased level of cyber security, since a different authentication signature might be used for this authentication, separate to any authentication information used to authenticate to the elevator controller. The authentication information required to access the safety controller may be provided to fewer maintenance personnel, e.g. a subset of maintenance personnel, compared to those provided with the authentication information required to access the elevator controller, thus improving security. For example, only certain users such as remote experts might be provided with the first authentication information needed to authenticate the remote computing device with the safety controller.

Furthermore, it will be appreciated that the safety controller and the elevator controller may each have independent connections to a drive system for the elevator car. In at least some examples, the elevator controller is connected to a drive system in order to control operation of the elevator car and the safety controller is independently connected to the drive system in order to prevent movement of the elevator car. The drive system may include a drive motor and a motor brake. The elevator controller may be configured to control operation of the drive motor (to move the car) and the motor brake (to stop the car), e.g. during normal operation of the elevator system. The safety controller may be configured to interrupt a power supply to the drive system so that the drive motor is prevented from operating and the motor brake is automatically applied, e.g. in response to an unsafe condition of the elevator system. By this it will be understood that the safety controller operates independently from the operation of the elevator controller to prevent movement of the elevator car (e.g. in an emergency stop situation), although the safety controller and the elevator controller may exchange information. For example, the safety controller may provide the individual status information to the elevator controller. The safety controller includes its own logic, by which the individual status of each safety contact is monitored and checked.

The plurality of safety contacts monitor the elevator system and are connected to the safety controller, e.g. over a bus. For example, the safety controller may be part of a safety system, the safety system also comprising bus nodes, which are connected to a bus, wherein the bus is connected to the safety controller, and the bus nodes are connected to the safety contacts. The bus may be a Controller Area Network (CAN) bus. However, any other suitable communication means may be employed to connect the safety controller to the safety contacts. The safety controller may include a microprocessor, which may run software. The microprocessor may poll the bus nodes, e.g. at regular intervals, to obtain the individual status information of the safety contacts.

In any of the examples described herein, any of the plurality of safety contacts may be a physical set of contacts or switch, for example a limit switch arranged in the hoistway, or alternatively a virtual set of contacts or switch embedded in software within the safety controller. For example, the safety controller may comprise suitable software which monitors the speed of the elevator car or the current draw of a drive motor which operates to drive the elevator car. Such virtual safety contacts may be configured to indicate an unsafe status, for example, upon detecting that the elevator car is moving too fast, or when the drive motor is drawing too much current.

The safety controller is configured to receive the individual status of each of the plurality of safety contacts. By receive it is meant that the safety controller might receive information which already indicates the status information of each safety contact individually, e.g. information received from a node, or might receive information from which said status information is then derived by the safety controller itself. In one particularly simple arrangement, at least one subset of the plurality of safety contacts are wired in parallel to each other, then connected to a bus node, such that the bus node knows, for each received status information signal, which safety contact sent that status information signal.

The safety controller is configured to be connected to a remote computing device. It will be understood that such a remote computing device is one which is located remotely relative to the elevator system, i.e. as opposed to being located locally at the elevator system. Such a remote computing device therefore does not require, and preferably does not have, a physical connection to the elevator system, but rather can be located far from the elevator system, e.g. could be located in a service centre far away.

Successful authentication of the remote computing device by the safety controller permits the remote computing device to override the safety controller, so as to enable movement of the elevator car. However, preferably the successful authentication itself does not automatically act to override the safety controller. Rather, in some examples, the safety controller is configured to receive an override command from the remote computing device before enabling movement of the elevator car. Thus, in some examples, the method further comprises the remote computing device sending an override command to the safety controller, and the safety controller receiving the override command before enabling movement of the elevator car.

The use of a separate override command, after successful authentication, ensures that the safety controller's prevention of elevator car movement is only carried out if specifically instructed by a user of the remote computing device, e.g. following an assessment of the status of the elevator system. This therefore allows a user of the remote computing device to assess the elevator system and then make an informed and reasoned decision as to whether to issue an override command Such a decision may be based, for example, on information received at the remote computing device which relates to the elevator system, including e.g. individual status information of each safety contact, information indicating the position of the elevator car, or whether there are passengers inside the elevator car. This helps to ensure that movement of the elevator car, in spite of an unsafe condition being indicated by one of the safety contacts, is only permitted when it is safe to do so, e.g. based on information reviewed by the user. For example, an override command may be sent to the safety controller when it has been assessed that the safety contact of a landing door has been accidentally triggered by an approaching car, which is a common problem caused by misalignment of the door coupling. In this situation an unsafe condition is indicated when the elevator car is close to a landing and the override command can be used to move the elevator car into alignment with the landing and release the trapped passengers. Thus, in at least some examples, the method comprises the remote computing device sending an override command to the safety controller when the individual status information is received from landing door safety contacts.

In some examples, additionally or alternatively, the elevator system further comprises a position determination system connected to the elevator controller and/or safety controller. The position determination system may be any position reference system that is capable of outputting a position of the elevator car within the hoistway. For example, the position determination system may comprise an encoder associated with the drive system, which is capable of outputting a position of the elevator car within the hoistway based on measurements related to the movement of the drive motor. In a set of examples, the position determination system is an absolute position determination system, i.e. which accurately determines the absolute position of the elevator car relative to a hoistway in which the elevator car travels. The position determination system advantageously collects (e.g. absolute) position information about the elevator car which can then be made available to a maintenance person, e.g. by means of the remote computing device. This position information may be used by the remote maintenance person to make a better informed decision about overriding the safety controller.

In some examples, control commands may be received by the safety controller, in order to assist with a rescue operation, thus requiring only a single authentication for the remote computing device. In some such examples, the position determination system provides position information to the safety controller. The safety controller may be configured to provide the position information to the remote computing device, if the remote computing device is authenticated by the safety controller. Thus, in some examples, the method further comprises the safety controller sending position information to the remote computing device once authenticated by the safety controller. This allows a user of the remote computing device to receive position information directly from the safety controller, which can then be used to determine whether it is safe to override the action of the safety controller to prevent movement of the elevator car. In addition to, or instead of, position information, the safety controller may also provide the status of each individual safety contact to the remote computing device, and/or a derived safety status of the elevator system (e.g. operation mode, or blockage conditions etc.), and/or other safety-related information not based on the safety contacts, e.g. relating to brake behaviour.

In some examples, additionally or alternatively, the safety controller is configured to receive an action command from the remote computing device and to control operation of the elevator car to carry out an action in response to the action command following authentication. Similarly, in some examples, the method further comprises the remote computing device sending an action command to the safety controller and the safety controller controlling operation of the elevator car to carry out an action in response to the action command following authentication. An action command may be, for example, a command to move the elevator car up or down the hoistway, or a command to open the doors of the elevator car. This further allows the user to directly control operation of the elevator car, e.g. to drive the car to a landing, and/or to open the elevator car doors, by directly communicating with the safety controller once the remote computing device is authenticated.

Alternatively, the remote computing device may further communicate with the elevator controller in order to restore operation of the elevator car. Thus, in some examples the elevator controller is configured to connect to the remote computing device, to receive second authentication information from the remote computing device, and to authenticate the remote computing device if the second authentication information meets an authentication condition. Thus a separate authentication is carried out between the remote computing device, and the elevator controller, which controls operation of the elevator car. This second authentication is separate from the first authentication by the safety controller, and may require separate security credentials. This second authentication information may be the same authentication information as is routinely used by maintenance personnel to obtain elevator system status information from the elevator controller, e.g. not only when an unsafe condition is indicated, but also during routine maintenance. This separate authenticated communication may allow the remote computing device to obtain useful information which is known to the elevator controller, and/or to transmit control signals to the elevator controller in order to control operation of the elevator car, without further involvement by the safety controller.

Thus, in some examples, the method further comprises: the remote computing device sending second authentication information to the elevator controller; the elevator controller checking whether the second authentication information meets an authentication condition; and if the second authentication information meets the authentication condition, authenticating the remote computing device. The method may, additionally or alternatively, comprise the elevator controller sending position information to the remote computing device following authentication.

The safety controller may be configured to provide the individual status information of each of the plurality of safety contacts to the elevator controller. In addition to, or instead of, position information, the elevator controller may also provide the status of each individual safety contact to the remote computing device. Thus, in some examples, the elevator controller is configured to receive the individual status information received from the safety contact that has indicated an unsafe condition and to send the individual status information to the remote computing device following authentication. In some examples the method may therefore comprise the safety controller sending to the elevator controller the individual status information received from the safety contact that has indicated an unsafe condition, and the elevator controller sending the individual status information to the remote computing device following authentication.

In some examples, additionally or alternatively, the elevator controller is configured to receive an action command from the remote computing device and to control operation of the elevator car to carry out an action in response to the action command following authentication. Thus, in some examples, the method further comprises the remote computing device sending an action command to the elevator controller, and the elevator controller controlling operation of the elevator car to carry out an action in response to the action command following authentication. Thus the user of the remote computing device can control operation of the elevator car (which is re-enabled following first authentication of the remote computing device by the safety controller and issuing of an override command), for example to drive the elevator car to a landing and/or open the elevator car doors.

In some examples, the present disclosure extends to a remote control system including the elevator system disclosed herein connected to the remote computing device referred to above. Thus, in some examples, the remote control system comprises a remote computing device, i.e. a device located remotely from the elevator system, on which is stored first authentication information. The remote computing device may be configured to connect to a (wireless) network. As laid out above, the remote computing device may be configured to authenticate with the safety controller using the first authentication information. The remote computing device may also store second authentication information. The remote computing device may be configured to authenticate with the elevator controller using the second authentication information. In some examples, the first authentication information and/or the second authentication information may be a certificate.

In some examples, additionally or alternatively, the first authentication information and/or the second authentication is asymmetrically encrypted (i.e. encryption which uses a public key together with a corresponding private key). This is a reliable and safe authentication method. For example, the remote computing device may be configured to asymmetrically encrypt a first set of credentials to provide the first authentication information. The remote computing device may be configured to encrypt the first set of credentials with a first public key or a first private key. The remote computing device may be configured to encrypt a second set of credentials with a second public key or a second private key to provide the second authentication information. The first set of credentials and the second set of credentials may be the same or different.

In some examples, the safety controller stores a first private key, and is configured to decrypt the encrypted first authentication information using the first private key. Alternatively, in other examples, the safety controller stores a first public key, and is configured to decrypt the encrypted first authentication information using the first public key. It will be understood that the first private key corresponds to the first public key, in the manner known in the field of asymmetric encryption. Thus, the (first) authentication condition (for authenticating the remote computing device to the safety controller) may be the successful decryption of the encrypted first authentication information using the first private or public key.

In some examples, additionally or alternatively to asymmetric encryption, the first authentication information and/or the second authentication information is symmetrically encrypted (i.e. encryption which uses a private key, known to both parties, for both encryption and decryption). In the case of symmetric key authentication the private key may be generated during an initial authentication round and be stored only for a particular communication session.

In some examples, the elevator controller stores a second private key, and is configured to decrypt the encrypted second authentication information using the second private key. Alternatively, in other examples, the elevator controller stores a second public key, and is configured to decrypt the encrypted second authentication information using the second public key. It will be understood that the second private key corresponds to the second public key, in the manner known in the field of asymmetric encryption. Thus, the (second) authentication condition, by which the remote computing device is authenticated by the elevator controller, may be the successful decryption of the encrypted second authentication information using the second private or public key.

In some embodiments, the first authentication information and/or the second authentication information may be generated by a (trusted) certificate authority. The remote computing device may send a first request and/or a second request containing the first public key and/or the second public key and the first and/or second set of credentials, respectively, to the certificate authority. The certificate authority may verify the information in the request and generate the first authentication information and/or the second authentication information by encrypting the first and/or second request with a certificate authority private key. This first and/or second authentication information may then be sent to the remote computing device, and stored on the remote computing device.

The safety controller may confirm that the certificate authority has verified the first authentication information and/or the second authentication information by decrypting the information using a certificate authority public key (i.e. a key corresponding to the certificate authority's private key). Thus, in some examples, the method further comprises the remote computing device encrypting a first set of credentials to provide the first authentication information using a (first) public key or a (first) private key. In some examples, the method further comprises the safety controller decrypting the first authentication information using a (first) private key, stored on the safety controller. Similarly, in some examples, the method further comprises the remote computing device encrypting a second set of credentials to provide the second authentication information using a second public key or a second private key. In some examples, the method further comprises the elevator controller decrypting the second authentication information using a second private key, stored on the elevator controller.

The safety controller may be configured to connect to the remote computing device over a (wired or wireless) communications network. The elevator controller may be configured to connect to the remote computing device over a (wired or wireless) communications network. In some examples the remote control system further comprises a wireless network, preferably a long-range wireless network such as a cloud-based network (e.g. the Internet). In some examples, the method further comprises the remote computing device and/or the safety controller, and/or the elevator controller connecting to a (wireless) communications network. The method may further comprise the remote computing device sending the first authentication information to the safety controller over the (wireless) communications network. The method may further comprise the remote computing device sending the second authentication information to the elevator controller over the (wireless) communications network.

### DRAWING DESCRIPTION

Certain preferred examples of this disclosure will now be described, by way of example only, with reference to the accompanying drawings, in which:

FIG. 1 is a schematic view of an elevator system according to an example of the present disclosure;

FIG. 2 is a schematic diagram showing a safety system and associated components, according to an example of the present disclosure;

FIG. 3 is a flow diagram showing a method of rescuing trapped passengers following an emergency stop of an elevator car, according to the prior art;

FIG. 4 is a flow diagram showing a method of rescuing trapped passengers following an emergency stop of an elevator car, according to the present disclosure; and

FIG. 5 is a schematic drawing representing an authentication request according to an example of the present disclosure.

### DETAILED DESCRIPTION

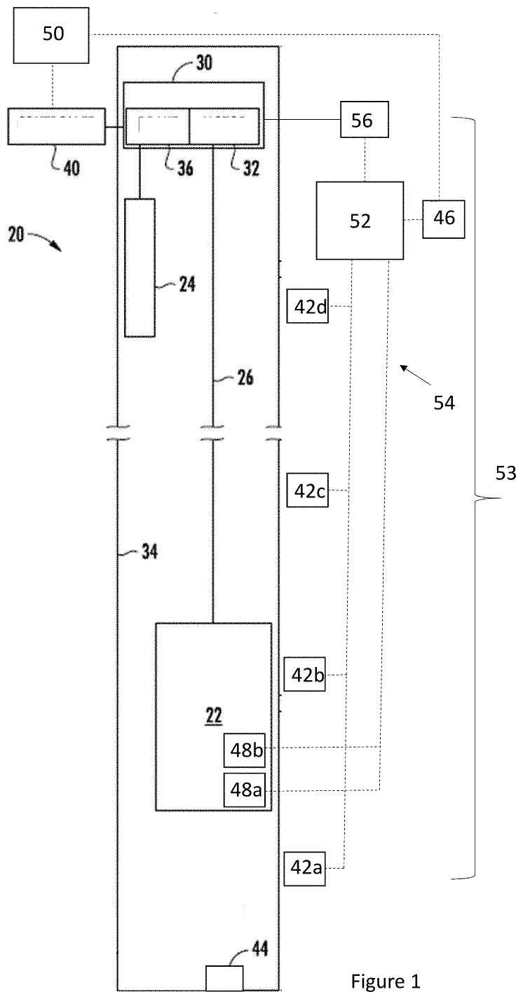

As shown in FIG. 1, an elevator system 20 comprises an elevator car 22 that runs in a hoistway 34 between various floors of a building. The elevator car 22 is suspended in the hoistway 34 by a tension member 26 (e.g. one or more ropes or belts). The other end of the tension member 26 is connected to a counterweight 24. The elevator car 22 and the counterweight 24 are moving components in the elevator system 20. However, it will be appreciated that in other examples the elevator system may be ropeless.

During normal operation, the elevator car 22 travels up and down in the hoistway 34 to transport passengers and/or cargo between floors of the building. The elevator car 22 is driven by a drive system 30 comprising a drive motor 32 and a motor brake 36. The tension member 26 passes over a drive sheave (not shown) that is driven to rotate by the drive motor 32 and braked by the motor brake 36. Normal operation of the drive system 30 is controlled by an elevator controller 40.

The elevator system 20 also comprises an absolute position measurement system 50 configured to determine the absolute position and velocity of the elevator car 22 in the hoistway 34. In this example, the absolute position measurement system 50 is configured to output a measurement of the absolute position and velocity of the elevator car 22 to the elevator controller 40. In other examples, the absolute position measurement system 50 may be connected to a safety controller 52 (described in more detail below), as well as or instead of its connection to the elevator controller 40. In such examples, the absolute position measurement system 50 can include a coded tape (not shown) extending at least part of the way along the hoistway 34 and two sensors (not shown) mounted on the elevator car 22 and arranged to read the coded tape to determine the absolute position and velocity of the elevator car 22 in the hoistway 34.

The elevator system 20 also comprises a safety system 53, including a safety controller 52 connected to a safety bus 54. As mentioned above, the absolute position measurement system 50 may also (or alternatively) be connected to a safety controller 52 over the safety bus 54, and may also (or alternatively) supply the position and velocity information to the safety controller 52.

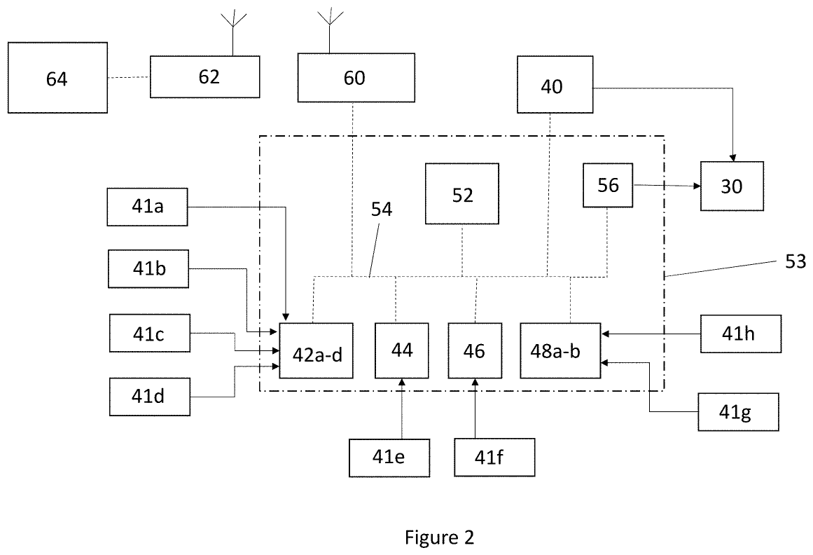

The safety controller 52 may be a node as defined in the relevant Programmable Electronic System in Safety Related Applications for Lifts (PESSRAL) standard(s). The safety controller 52 communicates over the safety bus 54 with a plurality of bus nodes 42a-d, 44, 46, 48a-b. The safety bus 54 may be a CAN bus, and is represented in FIGS. 1 and 2 with a dashed line.

The bus nodes 42a-d, 44, 46, 48a-b are each associated with one of a plurality of safety contacts located throughout the elevator system 20. In the particular example as shown, there are four landing door nodes 42a-d, each corresponding to a respective set of landing doors of the elevator system 20. There is a pit switch node 44, which is associated with a safety contact in the pit of the elevator system 20. This safety contact may be opened by a maintenance person when they are working in the pit. There is an overspeed node 46, associated with an overspeed switch or safety contact which detects an overspeed condition of the elevator car, and opens if an overspeed is detected. The overspeed node 46 is connected to the absolute position measurement system 50. There are also two nodes, 48a, 48b, associated with the safety contacts of the elevator car 22. In particular, there is an elevator door node 48a, connected to a door sensor, and an emergency stop node 48b.

The safety system 53 is shown in greater detail in FIG. 2, together with associated components. It can be seen that each of the nodes 42a-d, 44, 46, 48a-b is connected to at least one of the safety contacts 41a-41h, as described above. The safety system 53 also includes an actuator node 56, connected to the safety bus 54. If required, the actuator node 56 can interrupt the supply of power to the drive system 30 to execute an emergency stop, as described below. It will be understood that the actuator node 56 in the safety system 53 is configured to interrupt operation of the drive system 30 (e.g. upon detection of an unsafe condition) independently of the elevator controller 40 being configured to control the drive system 30 during normal operating conditions. Actuator node 56 simply allows or prevents movement of the elevator car 22, but cannot be used to drive the elevator car 22 to a floor. It is the elevator controller 40 which issues a run command to the drive system 30.

The safety bus 54 also connects the safety controller 52 to a wireless communications gateway 60, by means of which the safety controller 52 can wirelessly connect with a server 62 and further with a remote computing device 64 connected to said server 62, as described below.

The safety bus 54 is also connected to the elevator controller 40, such that the elevator controller 40 receives individual status information from the safety system 53, indicating the status of each of the safety contacts 41a-41g, i.e. whether each safety contact is open or closed. Thus, the safety controller 52 monitors and evaluates the individual status of each safety contact, but this information is also provided to the elevator controller 40 to facilitate maintenance work, e.g. by displaying the status of the individual safety contacts, or the overall safety chain, on devices in the elevator system.

At any point during normal operation an emergency stop of the elevator car 22 may be triggered, based on information obtained from the various nodes connected to the safety bus 54. For instance, if a hoistway door is opened (as detected by nodes 42a-d), if a maintenance worker is present in the pit of the hoistway (as detected by node 44) or, the elevator car 22 travels too quickly (as detected by overspeed node 46) an emergency stop may be executed, e.g. by interrupting the supply of power to the drive system 30 using the actuator node 56. The loss of power triggers the brake 36 to engage and stops the motor 32 (i.e. removes any drive torque applied to the drive sheave). This brings the elevator car 22 (and the counterweight 24) quickly to a halt.

Once the safety controller 52 has been triggered in this way, it is known for the elevator system to be configured such that the safety system 53 cannot then be overridden, and therefore movement of the elevator car restored, until a maintenance person attends the elevator system 20, in person, inspects the elevator system 20, and manually overrides the safety controller 52. In some cases passengers are inside the car when the emergency stop is carried out, and will therefore become trapped if the car is stopped between landings. Override of the safety controller 52, in order to allow the car to be moved to a landing, is required in order to rescue such trapped passengers.

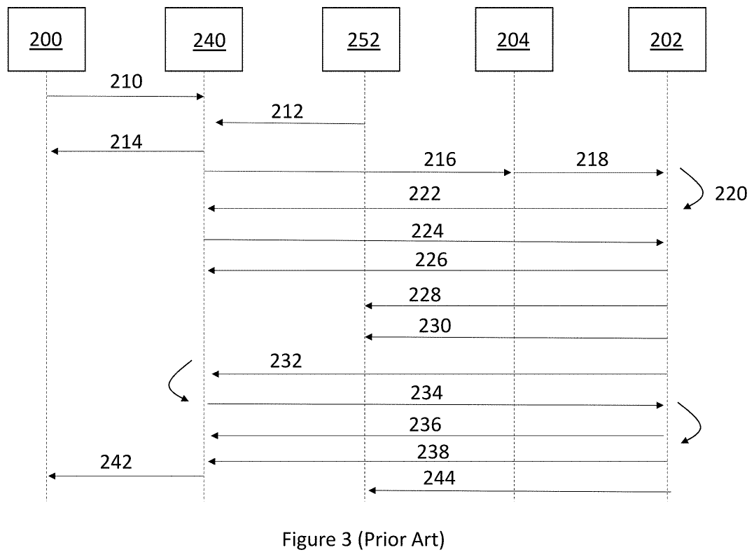

Such a known prior art method of rescuing trapped passengers following an emergency stop of an elevator car is described with reference to FIG. 3.

The method is carried out between a passenger or passengers 200 (who are trapped in an elevator car following an emergency stop) and a maintenance person or mechanic 202, who attends the elevator system physically in person to carry out a manual override of a safety controller 252. The method is carried out by communications between these two parties, by means of an elevator controller 240, the safety controller 252, and an elevator service 204 (where the server 62 is hosted for communication with the elevator controller 240 and the safety controller 252).

Initially, at step 210, the passenger is using the elevator car during normal operation. Then a signal at one of the bus nodes causes the safety controller 252 to provide a signal to the elevator controller 240, at step 212, which prevents movement of the elevator car. This causes the elevator car to undergo an emergency stop, which results, at step 214, in passengers becoming trapped. Passengers 200 then sound an alarm within the elevator car, which causes an alarm signal to be sent to the elevator service 204 at step 216. This elevator service 204 then signals a mechanic 202 at step 218.

Then, at step 220, as a result of receiving the signal, the mechanic 202 visits the elevator system. Once present locally on site, the mechanic 202 requests elevator status details from the elevator controller 240 at step 222. In response, at step 224, the elevator controller 240 responds by providing the status details of the elevator system.

These status details allow the mechanic 202 to identify which of the safety contacts needs to be bypassed in order to enable movement of the elevator car. Then, at step 226, the mechanic 202 informs the passengers 200 of the rescue operation via a speaker in the car, by means of the elevator controller.

At step 228 the mechanic 202 manually bypasses the safety contact which has triggered the emergency stop, where the mechanic has determined that it is safe to do so, and, at step 230, manually activates an emergency electrical operation of the elevator car.

Once the safety chain is bypassed, the mechanic is then able to manually run the car in an up or down direction, at step 232, using manual controls of the elevator controller 240, until the car arrives at a landing of the elevator system, at step 234. Once the car arrives at a landing, the mechanic 202 terminates the manual run command, at step 236, and manually opens the landing doors of the elevator car, at step 238.

Once the elevator doors are opened the passengers are able to exit the elevator car, and are therefore rescued (at step 242). Once the rescue operation is complete, the mechanic 202 then removes the bypass of the safety contact, at step 244. This process is time consuming since it requires a mechanic to physically attend the elevator system, and also requires a large amount of manual intervention by the mechanic.

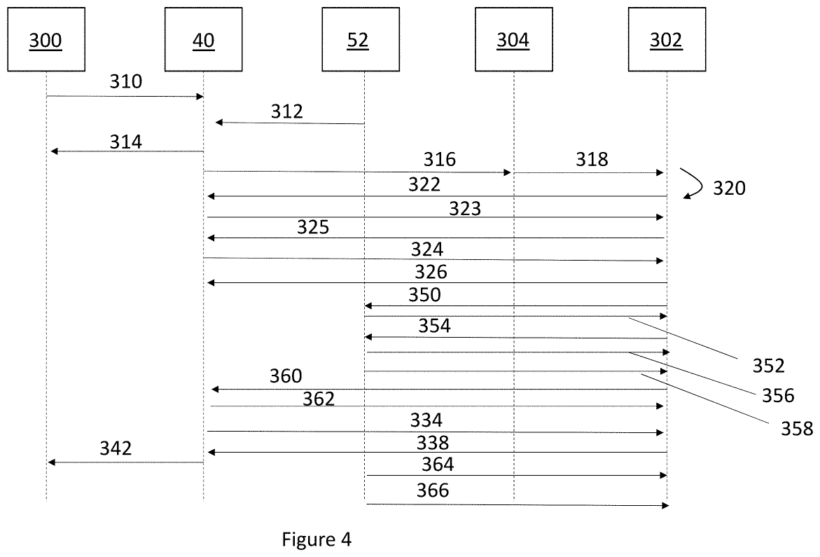

It is desirable that trapped passengers can be recovered as quickly and conveniently as possible, whilst also maintaining the safety and security of the elevator system. A method of rescuing trapped passengers following an emergency stop of an elevator car according to the present disclosure is shown in the flow diagram of FIG. 4.

The method is carried out between a passenger or passengers 300 (who are trapped in the elevator car 22 following an emergency stop) and a maintenance person or mechanic 302, who is using a remote computing device 64 (shown in FIG. 2). The method is carried out by communications between these two parties, by means of the elevator controller 40, the safety controller 52, and an elevator service 304.

Initially, at step 310, the passenger is using the elevator car during normal operation. Then a signal at one of the bus nodes causes the safety controller 52 to detect an unsafe condition and provide a signal to the actuator node 56 to interrupt the supply of power to the drive system 30, which prevents movement of the elevator car 22. Then, at step 312, the safety controller 52 will also notify the elevator controller 40 of the new status of the elevator system. The prevention of movement of the elevator car 22 causes the elevator car 22 to undergo an emergency stop. This results, at step 314, in passengers becoming trapped. Passengers 300 then sound an alarm within the elevator car 22, which causes an alarm signal to be sent to the elevator service 304 at step 316. This elevator service 304 then signals a mechanic, 302 at step 318.

At step 320, rather than physically attending the elevator system as in the prior art method described above, the mechanic 302 instead remotely accesses the elevator system, more specifically the safety controller 52 itself, as described below.

The remote computing device 64 first (or prior to the beginning of this method) establishes a data connection with an Otis server 62, as represented by the dashed line between the remote computing device 64 and the Otis server 62 in FIG. 2.

The Otis server 62 can communicate wirelessly, e.g. by means of respective antennae, with the gateway 60 which is connected to the safety bus 54 and therefore to the safety controller 52 and the elevator controller 40]. Thus the remote computing device 64 is able to communicate (e.g. exchange data and/or commands with) the safety controller 52, and the elevator controller 40.

At step 322, the mechanic 302 transmits a request to the elevator controller 40, via the wireless data connection to the gateway 60, requesting information about the elevator system 40, for example including the position of the elevator car and/or the status of each individual safety contact connected to the safety controller 52. The information may also include a variety of other information which is useful for elevator maintenance, for example a derived safety status of the elevator system (e.g. operation mode, or blockage conditions etc.), and other safety-related information not based on the safety contacts, e.g. relating to brake behaviour.

In order to ensure that such status information is not transmitted to a third party who is not entitled to access the information, e.g. a hacker, the elevator controller 40 requires the remote computing device 64 to undergo, and successfully pass, an authentication process, so that the information is only transmitted to authorised parties. To start this process, at step 323, the elevator controller 40 transmits a signal back to the remote computing device 64 indicating to the mechanic 302 that authorisation is required.

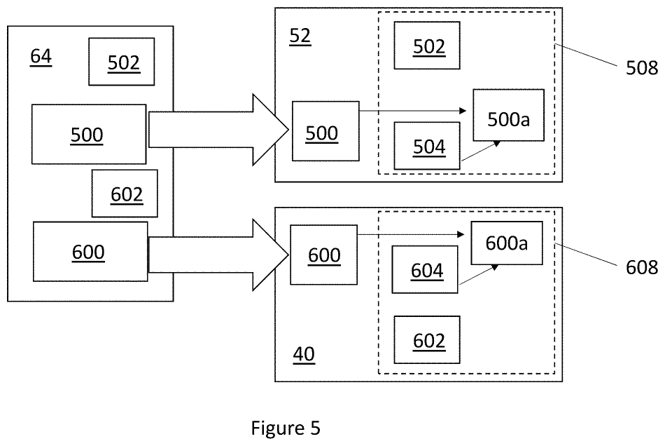

Then, at step 325, the mechanic 302 responds by providing authentication information to the elevator controller, in a process which is described in greater detail with respect to FIG. 5. The elevator controller 40 checks this information, as described below, and, if authentication is successful, sends a response to the remote computing device 64 at step 324, indicating that authentication of the remote computing device 64 has been granted, and providing the requested status information to the mechanic 302.

Based on the received information the mechanic 302 is then able to make an informed decision as to whether override of the safety controller 52 is required, e.g. if the elevator car is located between landings and so must be moved to a landing in order to allow passengers to exit, and also whether overriding of the safety controller 52 is a safe decision. If the mechanic 302 decides that override of the safety controller 52 is required, the method then proceeds as described below.

At step 326, the mechanic 302 informs the passengers 300 of the rescue operation via a speaker in the car, by means of the elevator controller 40.

In order to move the elevator car, the safety controller 52 must be overridden. Previously, a bypass was carried out by a maintenance person locally present at the elevator system, as described above, and therefore conventional security, e.g. security guards present at building entrances, prevent access of unauthorised parties. In the present method, the safety system 52 is accessible remotely by means of a wireless connection. Therefore, in order to ensure that only an authorised person is able to override the safety controller 40, authentication of the remote computing device 64 used by the mechanic 302, to the safety controller 52 is required. The remote computing device 64 must authenticate to the safety controller 52, separately to the authentication to the elevator controller 40 which is described above.

In a first step 350 the mechanic 302 sends an override command to the safety controller 52, instructing the safety controller 52 to re-enable movement of the elevator car, i.e. to override the safety contact which was opened to trigger the emergency stop. The safety controller 52 then sends a response to the remote computing device 64, at step 352, indicating the mechanic 302 that authorisation is required.

Then, at step 354, the mechanic 302 responds by providing authentication information to the safety controller 52, in a process which is described in greater detail with respect to FIG. 5. The safety controller 52 checks this information, as described below, and, if authentication is successful, sends a response to the remote computing device 64 at step 356, indicating that authentication of the remote computing device 64 has been granted. The safety controller 52 then executes the override command, so that movement of the elevator car 22 is once again enabled, despite a safety contact being open, and sends a signal at step 358 to the remote computing device 64, indicating that the override command has been executed.

Movement of the elevator car 22 is therefore once again possible. The elevator car may automatically move itself to the nearest landing, without specific instruction from the mechanic 302. Alternatively, as shown in FIG. 4, at step 360 the mechanic may send an explicit run command to the elevator controller 40, instructing the elevator car to begin travelling up or down the hoistway. At step 362, the elevator controller 40 transmits a signal to the remote computing device 64, indicating that the run command is in execution, i.e. that the elevator car is being moved, and then transmits a further signal at step 334, indicating that the elevator car has arrived at a landing.

Once the mechanic 302 is aware that the elevator car is stopped at the landing, the mechanic 302 then issues a door open command from the remote computing device 64 to the elevator controller 40, at step 338 in response to which the elevator car doors are opened, and as a result the passengers are rescued, at step 342.

Once the passengers have successfully been rescued, the override of the safety controller 52 is no longer required, and is in fact undesirable for safety purposes. Therefore, at step 364, the safety controller 52 sends a signal to the remote computing device 64, indicating that the override command has been terminated, so that operation of the elevator car is once again prevented, until the safety contact(s) have been “closed” to restore a normal operating condition of the elevator system. Then, at step 366, the authorisation of the remote computing device 64 to the safety controller 52 is terminated. In future, if the same mechanic 302 using the same remote computing device 64 wishes to override the safety controller 52, a new authentication to the safety controller 52 will therefore be required.

The authentication process described above with reference to FIG. 4 is represented in more detail in the schematic drawing FIG. 5, which shows an authentication process between a remote computing device 64 and, respectively, a safety controller 52, and an elevator controller 40.

As seen on the left hand side of FIG. 5, the remote computing device 64 stores a first certificate 500, and a first public key 502. This first public key 502 may not be permanently stored on the remote computing device 64, but may be retrieved from elsewhere when required.

A trusted certificate authority is used to generate the certificate. To do so, firstly the remote computing device 64 sends a request, containing the first public key 502 and remote computing device credentials (e.g. credentials encrypted with the first public key 502), to a certificate authority. The certificate authority verifies the information in the request and “digitally signs” the certificate with a certificate authority private key (which the certificate authority guarantees cannot be hacked). This certificate 500 is then sent to the remote computing device 64, where it is stored.

The certificate 500 is sent to the safety controller 52. The safety controller 52 can then confirm the certificate authority's digital signature using the certificate authority's public key, and can also confirm that the remote computing device 64 is in possession of the first public key, using a private key 504, also referred to as a factory key, stored on the safety controller 52—specifically on a smart card chip 508, e.g. by decrypting the credentials. The validity of the decrypted certificate 500a is then checked, e.g. it is checked whether the certificate is signed by a trusted certificate authority.

If the certificate is deemed to be valid, then the remote computing device 64 is considered to be verified.

Similarly, for authenticating to the elevator controller 40, the remote computing device 64 stores a second certificate 600, generated in the same manner as described above using a second public key 602 stored on the remote computing device 64. The safety controller 52 can then confirm the certificate authority's digital signature using the certificate authority's public key, and can also confirm that the remote computing device 64 is in possession of the second public key 602 using a second private key 604, also referred to as a factory key, stored on the safety controller 52—specifically on a smart card chip 608. The validity of the decrypted certificate 600a is then checked, e.g. it is checked whether the certificate is signed by a trusted certificate authority.

The certificate authority (and therefore the certificate authority private and public keys) can be the same for both the first and second certificates 500, 600, or different certificate authorities could be used to generate each.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. An elevator system (20), comprising:
an elevator car (22);
an elevator controller (40), configured to control operation of the elevator car (22); and
a safety controller (52) and a plurality of safety contacts connected to the safety controller (52), wherein the plurality of safety contacts monitor the elevator system (20),
wherein the safety controller (52) is configured to receive individual status information from each of the plurality of safety contacts and to prevent movement of the elevator car (22) when the individual status information received from one of the plurality of safety contacts indicates an unsafe condition of the elevator system (20);
wherein the safety controller (52) is configured to connect to a remote computing device (64), to receive first authentication information (500) from the remote computing device (64), and to authenticate the remote computing device (64) if the first authentication information (500) meets an authentication condition; and
if the remote computing device (64) is authenticated, to permit the remote computing device (64) to override the safety controller (52) to enable movement of the elevator car (22).

2. The elevator system (20) of claim 1, wherein the safety controller (52) is configured to receive an override command from the remote computing device (64) before enabling movement of the elevator car (22).

3. The elevator system (20) of claim 1, wherein the elevator controller (40) is configured to connect to the remote computing device (64), to receive second authentication information (600) from the remote computing device (64), and to authenticate the remote computing device (64) if the second authentication information (600) meets an authentication condition.

4. The elevator system of claim 3, wherein the elevator controller (40) is configured to receive an action command from the remote computing device (64) and to control operation of the elevator car (22) to carry out an action in response to the action command following authentication.

5. The elevator system of claim 3, wherein the elevator controller (40) is configured to receive the individual status information received from the safety contact that has indicated an unsafe condition and to send the individual status information to the remote computing device (64) following authentication.

6. The elevator system of claim 1, wherein the elevator system further comprises a position determination system (50) arranged to provide elevator car position information to the elevator controller (40) and/or safety controller (52), wherein the elevator controller (40) and/or safety controller (52) is configured to send the elevator car position information to the remote computing device (64) following authentication.

7. A remote control system comprising the elevator system of claim 1 and further comprising:
a remote computing device (64) on which is stored first authentication information (500), wherein the remote computing device is located remotely from the elevator system (20) and configured to connect to the elevator system (20) via a communications network.

8. The remote control system of claim 7, wherein second authentication information (600) is stored on the remote computing device (64),
the remote computing device (64) being configured to be authenticated by the elevator controller (40) using the second authentication information (600).

9. The remote control system of claim 7, wherein the remote computing device (64) is configured to asymmetrically encrypt the first authentication information (500).

10. A method of restoring operation of an elevator car (22) in an elevator system (20), when a safety controller (52) is preventing movement of the elevator car (22) since the individual status information from one of a plurality of safety contacts, received by the safety controller (52), indicates an unsafe condition of the elevator system (20), wherein an elevator controller (40) controls operation of the elevator car (20); the method comprising:
the safety controller (52) establishing a connection with a remote computing device;
the remote computing device (64) sending first authentication information (500) to the safety controller (52);
the safety controller (52) checking whether the first authentication information (500) meets an authentication condition; and
if the first authentication information (500) meets the authentication condition, authenticating the remote computing device (64); and
if the remote computing device (64) is authenticated, permitting the remote computing device (64) to override the safety controller (52) to enable movement of the elevator car (22).

11. The method of claim 10, further comprising:
the remote computing device (64) sending an override command to the safety controller (52); and
the safety controller (52) receiving the override command before enabling movement of the elevator car (22).

12. The method of claim 10, further comprising:
the remote computing device (64) sending second authentication information (600) to the elevator controller (40);
the elevator controller (40) checking whether the second authentication information (600) meets an authentication condition; and
if the second authentication information meets the authentication condition, authenticating the remote computing device (64).

13. The method of claim 11, further comprising: the remote computing device (64) sending an action command to the elevator controller (40); and
the elevator controller (40) controlling operation of the elevator car (22) to carry out an action in response to the action command following authentication.

14. The method of claim 10, further comprising: the remote computing device (64) encrypting the first authentication information (500) using a public key (502) and the safety controller (52) decrypting the first authentication information (500) using a private key (504) stored on the safety controller (52).

15. The method of claim 10, further comprising: the remote computing device (52) sending the first authentication information (500) to the safety controller (52) over a wireless network.
